(19) United States
(12) Patent Application Publication
(10) Pub. No.: US 2021/0230515 A1
(43) Pub. Date: Jul. 29, 2021

(54) FORMULATIONS, THE PRODUCTION AND USE THEREOF, AND SUITABLE COMPONENTS

(71) Applicant: BASF SE, Ludwigshafen am Rhein (DE)

(72) Inventors: Frank-Peter Lang, Ludwigshafen (DE); Holger Tuerk, Ludwigshafen (DE)

(21) Appl. No.: 15/734,945

(22) PCT Filed: May 29, 2019
(86) PCT No.: PCT/EP2019/064013

§ 371 Date: Dec. 3, 2020

(30) Foreign Application Priority Data
Jun. 6, 2018 (EP) 18176308.7

(51) Int. Cl. C11D 3/37; C11D 11/00; C11D 3/33; C11D 3/20; C11D 3/39; C11D 17/00

(52) U.S. Cl. CPC C11D 3/3788; C11D 11/0023; C11D 3/3757; C11D 17/003; C11D 3/2086; C11D 3/3942; C11D 3/33

(57) ABSTRACT

A solid, liquid, or gel formulation including: (A) alkali metal sulfite or alkali metal bisulfite, and (B) at least one graft copolymer formed from: at least one graft base selected from nonionic monosaccharides, disaccharides, oligosaccharides, and polysaccharides, and side chains obtainable by grafting of at least one ethylenically unsaturated mono- or dicarboxylic acid and at least one compound of the general formula (I),

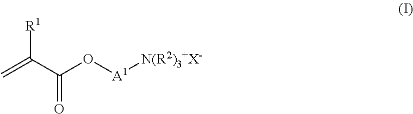

where the variables are each defined as follows:

R¹ is chosen from methyl and hydrogen,

A¹ is chosen from C₂-C₄-alkylene,

R² are the same or different and chosen from C₁-C₄-alkyl,

X⁻ is chosen from halide, mono-C₁-C₄-alkylsulfate and sulfate,

where alkali metal (bi)sulfite (A) and graft copolymer (B) are present in a weight ratio in the range from 1:100 to 10:1.

The present application relates to solid, liquid or gel formulations comprising

(A) at least one sulfite selected from ammonium sulfite, ammonium bisulfite, alkali metal sulfite and alkali metal bisulfite,

(B) at least one graft copolymer formed from
(a) at least one graft base selected from nonionic monosaccharides, disaccharides, oligosaccharides and polysaccharides, and side chains obtainable by grafting of
(b) at least one ethylenically unsaturated mono- or dicarboxylic acid and
(c) at least one compound of the general formula (I),

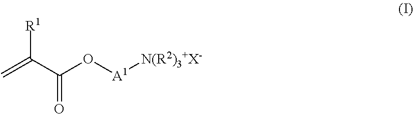

where the variables are each defined as follows:

R¹ is chosen from methyl and hydrogen,

A¹ is chosen from C₂-C₄-alkylene,

R² are the same or different and chosen from C₁-C₄-alkyl,

X⁻ is chosen from halide, mono-C₁-C₄-alkylsulfate and sulfate,

where ammonium (bi)sulfite (A) or alkali metal (bi)sulfite (A) and graft copolymer (B) are present in a weight ratio in the range from 1:100 to 10:1.

Dishwashing detergents have to meet a variety of demands. For instance, they have to thoroughly clean the dishware, they should not include any substances that are harmful or potentially harmful in the wastewater, they should permit the runoff and drying of the water from the dishware, and the soil constituents removed must be dispersed or emulsified in such a sustainable way that they are not deposited on the surface of the ware. The dishwashing detergents should not lead to problems in the operation of the machine dishwasher. Finally, they should not lead to any esthetically undesired consequences on the ware to be cleaned. In particular, there should be no occurrence of whitish spots or deposits which arise owing to the presence of lime or other inorganic and organic salts in the course of drying of water droplets or are precipitated on the ware actually during the wash operation as a result of deposition of soil constituents or inorganic salts.

However, the trend toward phosphate-free cleaning compositions, which should also still be used without rinse aid and ion exchanger, requires new solutions. In phosphate-free dishwashing detergents, the composition of the salts obtained is different than that in phosphate-containing detergents, and so the polymers used to date are insufficiently active in many cases. Particularly with regard to film inhibition, phosphate-free dishwashing detergents are still in need of improvement.

EP 2 138 560 A1 discloses graft copolymers and the use thereof in compositions for cleaning of hard surfaces, including as dishwashing detergents. However, the detergents proposed in EP 2 138 560 A1 have inadequate film inhibition in some cases, for example as dishwashing detergents on cutlery such as knives and especially on glass.

WO 2015/197379 and WO 2017/186524 disclose formulations which comprise a graft copolymer and additionally a builder chosen from MGDA and GLDA and salts thereof. The formulations disclosed do show good film inhibition—especially in phosphate-free compositions and especially on glass. However, some of the formulations disclosed can become discolored over a prolonged shelf life.

The problem addressed was therefore that of providing formulations that have not just very good film inhibition—especially in phosphate-free compositions—especially on glass, but also good storage stability. A further problem addressed was that of providing a process by which it is possible to produce formulations having a very good film inhibition—especially in phosphate-free compositions. A final problem addressed was that of providing suitable components for such formulations.

Accordingly, the formulations defined at the outset have been found, which are also called formulations of the invention in the context of the present invention.

Formulations of the invention may be solid or liquid at room temperature, i.e. at 20° C. Formulations of the invention are preferably in liquid or gel form at room temperature.

Formulations of the invention that are liquid at 20° C. may comprise 30% to 90% by weight of water, preferably 40% to 80% by weight. In such embodiments, the water content can be determined by determining the dry residue at 80° C. under reduced pressure. Formulations of the invention that are liquid at room temperature may, for example, be in gel or paste form.

Formulations of the invention that are solid at room temperature may be anhydrous or comprise water, for example up to 20% by weight, preferably 0.1% to 10% by weight of water, determinable, for example, by Karl Fischer titration or by determining the dry residue at 80° C. under reduced pressure. Formulations of the invention that are solid at room temperature may, for example, be in the form of powder, granules or tablets.

Formulations of the Invention Comprise

(A) at least one sulfite selected from ammonium sulfite, ammonium bisulfite, alkali metal sulfite and alkali metal bisulfite, also called (bi)sulfite (A) or ammonium (bi)sulfite (A) or alkali metal (bi)sulfite (A) for short. Preferred (bi)sulfite (A) is chosen from alkali metal (bi)sulfite (A). Particular preference is given to choosing alkali metal (bi)sulfite (A) from the sodium and potassium salts. Examples are Na₂SO₃, NaHSO₃, K₂SO₃ and KHSO₃. Preference is given to the respective sodium salts.

Particular preference is given to choosing (bi)sulfite (A) Na₂SO₃, NaHSO₃, K2S03 and KHSO₃, and refraining from the use of ammonium (bi)sulfite.

Formulations of the Invention Further Comprise

(B) at least one graft copolymer, also called graft copolymer (B) in the context of the present invention, formed from

(a) at least one graft base, called graft base (a) for short, selected from nonionic monosaccharides, disaccharides, oligosaccharides and polysaccharides, and side chains obtainable by grafting of

(b) at least one ethylenically unsaturated mono- or dicarboxylic acid, called monocarboxylic acid (b) or dicarboxylic acid (b) for short, and

(c) at least one compound of the general formula (I), called monomer (c) or compound (c) or compound (I) for short,

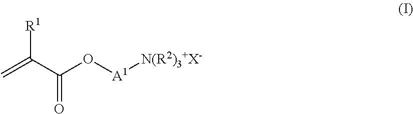

where the variables are each defined as follows:

R¹, is chosen from methyl and hydrogen,

A¹ is chosen from C₂-C₄-alkylene,

R² are the same or different and chosen from C₁-C₄-alkyl,

X⁻ is chosen from halide, mono-C₁-C₄-alkylsulfate and sulfate.

Nonionic monosaccharides chosen that are suitable as graft base (a) may, for example, be aldopentoses, pentuloses (ketopentoses), aldohexoses and hexuloses (ketohexoses). Suitable aldopentoses are, for example, D-ribose, D-xylose and L-arabinose. Aldohexoses include D-glucose, D-mannose and D-galactose; examples of hexuloses (ketohexoses) include D-fructose and D-sorbose in particular.

In the context of the present invention, deoxy sugars, for example L-fucose and L-rhamnose, shall also be counted as nonionic monosaccharides.

Examples of nonionic disaccharides include, for example, cellobiose, lactose, maltose and sucrose.

Nonionic oligosaccharides in the context of the present invention include nonionic carbohyrates having three to ten nonionic monosaccharide units per molecule, for example glycans. Nonionic polysaccharides in the context of the present invention refer to nonionic carbohydrates having more than ten nonionic monosaccharide units per molecule. Nonionic oligo- and poly-saccharides may, for example, be linear, cyclic or branched.

Examples of nonionic polysaccharides include biopolymers such as starch and glycogen, and also cellulose and dextran. Mention should also be made of inulin as a polycondensate of D-fructose (fructans) and chitin. Further examples of nonionic polysaccharides are nonionic starch degradation products, for example products that can be obtained by enzymatic or so-called chemical degradation of starch. One example of so-called chemical degradation of starch is acid-catalyzed hydrolysis.

Preferred examples of nonionic starch degradation products are maltodextrins. In the context of the present invention, maltodextrin is understood to mean mixtures of monomers, dimers, oligomers and polymers of glucose. The percentage composition differs according to the degree of hydrolysis. This is described by the dextrose equivalent, which is between 3 and 40 for maltodextrin.

Graft base (a) is preferably chosen from nonionic polysaccharides, especially from starch, preferably in chemically unmodified form, hydroxyl groups of which, for example, have preferably neither been esterified nor etherified. In one embodiment of the present invention, starch is chosen from those nonionic polysaccharides that have in the range from 20% to 30% by weight of amylose and in the range from 70% to 80% by weight of amylopectin. Examples are corn starch, rice starch, potato starch and wheat starch.

Side chains have been grafted onto the graft base (a). An average of one to ten side chains may preferably have been grafted on per molecule of graft copolymer (B). Preferably, one side chain has been joined to the anomeric carbon atom of a monosaccharide or to an anomeric carbon atom of the chain end of an oligo- or polysaccharide. The number of side chains is limited at the upper end by the number of carbon atoms having hydroxyl groups in the graft base (a) in question.

Examples of monocarboxylic acids (b) are ethylenically unsaturated C₃-C₁₀ monocarboxylic acids and the alkali metal or ammonium salts thereof, especially the potassium and sodium salts. Preferred monocarboxylic acids (b) are acrylic acid and methacrylic acid, and also sodium (meth)acrylate. Mixtures of ethylenically unsaturated C₃-C₁₀ monocarboxylic acids and especially mixtures of acrylic and methacrylic acid are also preferred components (b).

Examples of dicarboxylic acids (b) are ethylenically unsaturated C₄-C₁₀ dicarboxylic acids and mono- and especially dialkali metal or ammonium salts, especially the dipotassium and disodium salts, and anhydrides of ethylenically unsaturated C₄-C₁₀ dicarboxylic acids. Preferred dicarboxylic acids (b) are maleic acid, fumaric acid, itaconic acid, and also maleic anhydride and itaconic anhydride.

In one embodiment, graft copolymer (B) comprises, in at least one side chain, as well as monomer (c), at least one monocarboxylic acid (b) and at least one dicarboxylic acid (b). In a preferred embodiment of the present invention, graft copolymer (B) comprises, in the side chains, aside from monomer (c), exclusively monocarboxylic acid (b) and no dicarboxylic acid (b) in copolymerized form.

Monomers (c) are ethylenically unsaturated N-containing compounds having permanent cationic charge.

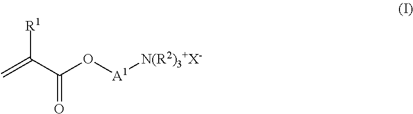

where the variables are each defined as follows:

R¹ is chosen from methyl and hydrogen,

A¹ is chosen from C₂-C₄-alkylene, for example —CH₂—CH₂—, CH₂—CH(CH₃)—, —(CH₂)₃—, —(CH₂)₄—, preference being given to —CH₂—CH₂— and —(CH₂)₃—,

R² are different or preferably the same and are chosen from C₁-C₄-alkyl, for example methyl, ethyl, n-propyl, n-butyl, isopropyl, isobutyl, sec-butyl, tert-butyl; preferably, at least two R² are the same and are each methyl, and the third R² group is ethyl, n-propyl or n-butyl, or two R² are the same and are each ethyl, and the third R² group is methyl, n-propyl or n-butyl. More preferably, all three R² are the same and are chosen from methyl.

X⁻ is chosen from halide, for example iodide, bromide and especially chloride, and also from mono-C₁-C₄-alkylsulfate and sulfate. Examples of mono-C₁-C₄-alkylsulfate are methylsulfate, ethylsulfate, isopropylsulfate and n-butylsulfate, preference being given to methylsulfate and ethylsulfate. When X⁻ is chosen as sulfate, X⁻ represents half an equivalent of sulfate.

In a preferred embodiment of the present invention, in monomer (c), the variables are chosen as follows:

R¹ is hydrogen or methyl,

R² are the same and are each methyl,

A¹ is CH₂CH₂, and

X⁻ is chloride.

In one embodiment of the present invention, monomer (c) is chosen from

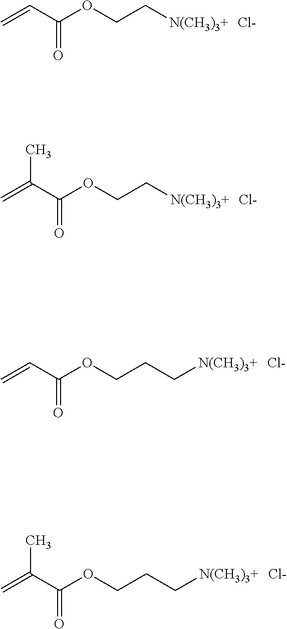

Graft copolymer (B) may comprise, in one or more side chains, at least one further comonomer (d) in copolymerized form, for example hydroxyalkyl esters such as 2-hydroxyethyl (meth)acrylate or 3-hydroxypropyl (meth)acrylate, or esters of alkoxylated fatty alcohols, or comonomers containing sulfo groups, for example 2-acrylamido-2-methylpropanesulfonic acid (AMPS) and alkali metal salts thereof.

Preferably, graft copolymer (B), apart from monomer (c) and monocarboxylic acid (b) or dicarboxylic acid (b), does not comprise any further comonomers (d) in one or more side chains.

In one embodiment of the present invention, the proportion of graft base (a) in graft copolymer (B) is in the range from 40% to 95% by weight, preferably from 50% to 90% by weight, based in each case on overall graft copolymer (B).

In one embodiment of the present invention, the proportion of monocarboxylic acid (b) or dicarboxylic acid (b) is in the range from 2% to 40% by weight, preferably from 5% to 30% by weight and especially from 5% to 25% by weight, based in each case on the overall graft copolymer (B).

Monomer(s) (c) is/are copolymerized in amounts in the range from 5% to 50% by weight, preferably from 5% to 40% by weight and more preferably from 5% to 30% by weight, based in each case on overall graft copolymer (B).

It is preferable when graft copolymer (B) comprises more monocarboxylic acid (b) in copolymerized form than monomer (c), specifically, based on molar proportions, for example, in the range from 1.1:1 to 5:1, preferably 2:1 to 4:1.

In one embodiment of the present invention, the average molecular weight (M_{w}) of graft copolymer (B) is in the range from 1500 to 200 000 g/mol, preferably from 2000 to 150 000 and especially in the range from 3000 to 100 000 g/mol. Average molecular weight M_{w}, is preferably measured by gel permeation chromatography (GPC) in aqueous KCl/formic acid solution.

(Bi)sulfite (A) and graft copolymer (B) are present in a weight ratio in the range from 1:100 to 10:1, preferably in the range from 1:50 to 2:1 and more preferably in the range from 1:20 to 1:1.

In a preferred embodiment, (bi)sulfite (A) is chosen from alkali metal (bi)sulfite, and alkali metal (bi)sulfite (A) and graft copolymer (B) are present in a weight ratio in the range from 1:100 to 10:1, preferably in the range from 1:50 to 2:1 and more preferably in the range from 1:20 to 1:1.

Optionally, solution of graft copolymer (B) or dried graft copolymer (B) can be used for production of the formulations of the invention.

It is preferable to stabilize graft copolymer (B) by means of at least one biocide. Examples of suitable biocides are isothiazolinones, for example 1,2-benzisothiazolin-3-one (“BIT”), octyli-sothiazolinone (“OIT”), dichlorooctylisothiazolinone (“DCOIT”), 2-methyl-2H-isothiazolin-3-one (“MIT”) and 5-chloro-2-methyl-2H-isothiazolin-3-one (“CIT”), phenoxyethanol, alkylparabens such as methylparaben, ethylparaben, propylparaben, benzoic acid and salts thereof, for example sodium benzoate, benzyl alcohol, alkali metal sorbates, for example sodium sorbate, and optionally substituted hydantoins, for example 1,3-bis(hydroxymethyl)-5,5-dimethylhydantoin (DMDM hydantoin). Further examples are 1,2-dibromo-2,4-dicyanobutane, iodo-2-propynyl bu-tylcarbamate, iodine and iodophores. Further examples are quaternary ammonium salts, for example dialkyldimethylammonium salts, e.g. didecyldimethylammonium chloride or benzyl-dimethylalkylammonium chloride, and cationic polyelectrolytes such as polydimethyldiallylammonium chloride.

In one embodiment of the present invention, formulation of the invention is free of phosphates and polyphosphates, including hydrogenphosphates, for example free of trisodium phosphate, pentasodium tripolyphosphate and hexasodium metaphosphate. “Free of” in connection with phosphates and polyphosphates in the context of the present invention shall be understood to mean that the phosphate and polyphosphate content in total is in the range from 10 ppm to 0.2% by weight, determined by gravimetry.

In one embodiment of the present invention, formulation of the invention is free of those heavy metal compounds that do not act as bleach catalysts, especially of compounds of iron. “Free of” in connection with heavy metal compounds in the context of the present invention shall be understood to mean that the content of heavy metal compounds that do not act as bleach catalysts in total is in the range from 0 to 100 ppm, preferably 1 to 30 ppm, determined by the leach method.

“Heavy metals” in the context of the present invention are considered to be all metals having a specific density of at least 6 g/cm³, excluding manganese, zinc and bismuth. More particularly, heavy metals are precious metals, and also iron, copper, lead, tin, nickel, cadmium and chromium.

In one embodiment of the present invention, formulation of the invention comprises a total of in the range from 0.005% to 2.0% by weight of (bi)sulfite (A), preferably alkali metal (bi)sulfite (A), preferably 0.01% to 1.0% by weight, more preferably 0.02% to 0.5% by weight; a total of in the range from 0.05% to 4% by weight of graft copolymer (B), preferably 0.1% to 4% by weight, more preferably 0.2% to 2.0% by weight, based in each case on the solids content of the formulation of the invention in question. The solids content is preferably determined at 80° C. under reduced pressure.

In one embodiment, formulations of the invention may comprise one or more enzymes, for example 0.1% to 5% by weight of enzyme, based on solids content. Examples of enzymes are lipases, hydrolases, amylases, proteases, cellulases, esterases, pectinases, lactases and peroxidases.

In a preferred embodiment of the present invention, formulations of the invention, however, are free of enzymes, i.e. less than 0.01% by weight of enzyme and preferably no measurable proportions of enzyme, based in each case on solids content.

Enzyme-free formulations of the invention are generally also free of enzyme stabilizers such as protease inhibitors, for example benzamidine hydrochloride, borax, boric acids, boronic acids or salts or esters thereof.

In one embodiment of the present invention, formulations of the invention comprise at least one complexing agent (C) chosen from alkali metal salts of methylglycinediacetic acid (MGDA), glutamic acid diacetate (GLDA) and citric acid, and combinations of at least two of the above.

MGDA and GLDA may be in racemic form or in the form of an enantiomerically pure compound. GLDA is preferably chosen from L-GLDA or enantiomerically enriched mixtures of L-GLDA in which there is at least 80 mol %, preferably at least 90 mol %, of L-GLDA.

In one embodiment of the present invention, complexing agent (C) is chosen from racemic MGDA. In another embodiment of the present invention, complexing agent (C) is chosen from L-MGDA or from enantiomeric mixtures of L- and D-MGDA in which L-MGDA predominates and in which the molar L/D ratio is in the range from 55:45 to 95:5, preferably 60:40 to 85:15. The molar L/D ratio can be determined, for example, by polarimetry or by chromatography, preferably by HPLC with a chiral column, for example with cyclodextrin as the stationary phase or with an optically active ammonium salt immobilized on the column. For example, it is possible to use an immobilized D-penicillamine salt.

MGDA or GLDA is preferably used in salt form. Preferred salts are ammonium salts and alkali metal salts; particular preference is given to the potassium and especially sodium salts. These may have, for example, the general formula (II) or (III):

[CH₃-CH(COO)-N(CH₂-COO)₂]Na_{3-x-y}KₓH_{y} (II)

x is in the range from 0.0 to 0.5, preferably to 0.25,

y is in the range from 0.0 to 0.5, preferably to 0.25.

[OOC-)CH₂)₂-CH(COO)-N(CH₂-COO)₂]Na_{4-x-y}KₓH_{y} (III)

x is in the range from 0.0 to 0.5, preferably to 0.25,

y is in the range from 0.0 to 0.5, preferably to 0.25.

Very particular preference is given to the trisodium salt of MGDA and the tetrasodium salt of GLDA.

Complexing agent (C) may comprise cations other than alkali metal ions in small amounts, for example Mg²⁺, Ca²⁺, or iron ions, for example Fe²⁺ or Fe³⁺. Such ions are in many cases present in complexing agent (C) for preparation-related reasons. In one embodiment of the present invention, cations other than alkali metal ions are present in the range from 0.01 to 5 mol %, based on overall MGDA or overall GLDA.

In another embodiment of the present invention, no measurable proportions of cations other than alkali metal ions are present in complexing agent (C).

In one embodiment of the present invention, complexing agent (C) comprises small amounts of one or more impurities that may be for preparation-related reasons. In the case of MGDA, these may be, for example, propionic acid, alanine or lactic acid. Small amounts here are proportions, for example, in the range from 0.01% to 1% by weight, based on complexing agent (C). Such impurities are neglected in the context of the present invention unless explicitly stated otherwise.

In one embodiment of the present invention, formulation of the invention comprises one complexing agent (C), for example solely trisodium salt of MGDA or solely tetrasodium salt of GLDA. Compounds of the formula (II) or (III) with non-zero x or y shall also each be referred to here as one compound.

In another embodiment of the present invention, formulation of the invention comprises two complexing agents (C), for example a mixture of trisodium salt of MGDA and tetrasodium salt of GLDA, for example in a molar ratio in the range from 1:1 to 1:10.

In one embodiment of the present invention, formulations of the invention comprise 20% to 95% by weight of complexing agent (C), preferably from 30% to 90% by weight, more preferably from 40% to 80% by weight, of complexing agent (C). It is immaterial here in the context of the present invention whether complexing agents (C) such as MGDA or GLDA or the corresponding salts are in enantiomerically pure or racemic form or in the form of an enantiomerically enriched mixture.

Citrates, GLDA and MGDA and the alkali metal salts thereof may be in the form of hydrates. Unless explicitly stated otherwise, in the context of the present invention, stated amounts in connection with MGDA or GLDA or the alkali metal salts thereof are always based on the active ingredient, i.e. without taking account of hydrate.

Formulations of the invention that are in liquid form and especially in gel form are free of bleaches (D), for example free of inorganic peroxide compounds such as H₂O₂ or chlorine bleaches such as sodium hypochlorite. What is meant here by “free of bleaches (D)” is that such formulations of the invention do not comprise any detectable proportions of inorganic peroxide compounds and chlorine bleaches. Any bleaches (D) present would react immediately with (bi)sulfite (A), for example alkali metal (bi)sulfite (A).

Formulations of the invention that are solid at room temperature may comprise one or more bleaches (D) chosen from inorganic peroxide compounds and chlorine bleaches.

In one embodiment of the present invention, solid formulations of the invention comprise

(D) at least one inorganic peroxide compound, also referred to in the context of the present invention as peroxide (D) for short. Peroxide (D) is chosen from sodium peroxodisulfate, sodium perborate and sodium percarbonate, preference being given to sodium percarbonate.

Peroxide (D) may be anhydrous or may preferably contain water. An example of water-containing sodium perborate is Na₂[B(OH)₂(O₂)]₂), sometimes also written as NaBO₂·O₂·3H₂O. An example of water-containing sodium percarbonate is 2 Na₂CO₃·3 H₂O₂. Peroxide (D) is more preferably chosen from water-containing percarbonates.

Percarbonates and especially sodium percarbonate are preferably used in coated form. The coating may be inorganic or organic in nature. Examples of coating agents are sodium sulfate, silica gel, sodium silicate, sodium carbonate and combinations of at least two of the above coating agents, for example sodium carbonate and sodium sulfate. Further suitable coating agents are waxy substances, for example fatty alcohols or fatty acid or salts thereof.

Preferably, formulation of the invention comprises in the range from 1% to 20% by weight of peroxide (D), preferably 2% to 12% by weight, more preferably 3% to 12% by weight, based on solids content of the formulation in question.

In another embodiment, solid formulation of the invention comprises

(D) at least one chlorine-containing bleach, which is also referred to in the context of the present invention as chlorine bleach (D) for short. Chlorine bleach (D) is preferably sodium hypochlorite.

Formulations of the invention containing chlorine bleach (D) are preferably liquid at room temperature.

Preferably, formulation of the invention comprises in the range from 0.1% to 20% by weight of chlorine bleach (D), preferably 0.5% to 12% by weight, more preferably 1% to 12% by weight, based on solids content of the liquid formulation in question.

Formulations of the invention may comprise one or more further constituents (E). Constituents (E) are different than complexing agent (C), graft copolymer (B) and bleaches (D) and may be chosen from one or more surfactants, one or more builders, especially phosphate-free builders, one or more cobuilders, one or more alkali carriers, one or more acids, one or more defoamers, one or more corrosion inhibitors, one or more buffers, dyes, color pigments, fragrances, thickeners, one or more organic solvents, one or more biocides or one or more solubilizers.

Examples of surfactants are especially nonionic surfactants and mixtures of anionic or zwitterionic surfactants with nonionic surfactants. Preferred nonionic surfactants are alkoxylated alcohols and alkoxylated fatty alcohols, di- and multiblock copolymers of ethylene oxide and propylene oxide, and reaction products of sorbitan with ethylene oxide or propylene oxide, alkyl glycosides and what are called amine oxides.

Preferred examples of alkoxylated alcohols and alkoxylated fatty alcohols are compounds of the general formula (IV)

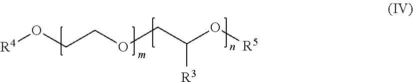

in which the variables are defined as follows:

R³ is the same or different and is chosen from linear C₁-C₁₀-alkyl, preferably ethyl and more preferably methyl,

R⁴ is chosen from C₈-C₂₂-alkyl, for example n-C₈H₁₇, n-C₁₀H₂₁, n-C₁₂H₂₅, n-C₁₄H₂₉, n-C₁₆H₃₃ or n-C₁₈F₃₇, or mixtures of at least two of the above alkyl radicals,

R⁵ is chosen from hydrogen and C₁-C₁₀-alkyl, methyl, ethyl, n-propyl, isopropyl, n-butyl, iso-butyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

m and n are in the range from zero to 300, where the sum total of n and m is at least one. Preferably, m is in the range from 1 to 100 and n in the range from 0 to 30.

Compounds of the general formula (IV) may be block copolymers or random copolymers, preferably block copolymers.

Other preferred examples of alkoxylated alcohols and alkoxylated fatty alcohols are compounds of the general formula (V)

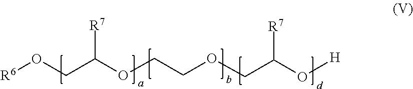

in which the variables are defined as follows:

R⁶ is chosen from C₆-C₂₀-alkyl, especially n-C₈H₁₇, n-C₁₀H₂₁, n-Ci2H25, n-C₁₄H29, n-C₁₆H₃₃, n-C₁₈H₃₇,

R⁷ is the same or different and is chosen from linear C₁-C₄-alkyl, is preferably the same each time and is ethyl and is more preferably methyl.

a is a number in the range from 1 to 6,

b is a number in the range from 4 to 20,

d is a number in the range from 4 to 25.

Compounds of the general formula (V) may be block copolymers or random copolymers, preferably block copolymers.

Other preferred examples of alkoxylated alcohols and alkoxylated fatty alcohols are mixed hydroxy ethers of the general formula (VI)

R⁸—CH(OH)—CH₂—O—(AO)ₖ—R⁹ (VI)

where the variables are chosen as follows:

R⁸ is C₄-C₃₀-alkyl, branched or unbranched, or
C₄-C₃₀-alkenyl, branched or unbranched, with at least one C—C double bond.

R⁸ is preferably chosen from C₄-C₃₀-alkyl, branched or unbranched, more preferably un-branched C₄-C₃₀-alkyl and most preferably n-C₁₀-C₁₂-alkyl.

R⁹ is C₁-C₃₀-alkyl, branched or unbranched, or C₂-C₃₀-alkenyl, branched or unbranched, with at least one C—C double bond.

R⁹ is preferably chosen from C₄-C₃₀-alkyl, branched or unbranched, more preferably un-branched C₆-C₂₀-alkyl and most preferably n-C₈-C₁₁-alkyl.

k is a number in the range from 1 to 100, preferably from 5 to 60, more preferably 10 to 50 and most preferably 15 to 40,

AO is chosen from alkylene oxide, differently or identically and chosen from CH₂-CH₂-O, (CH₂)₃-O, (CH₂)₄-O, CH₂CH(CH₃)—O, CH(CH₃)-CH₂—O— and CH₂CH(n-C₃H₇)—O. A preferred example of AO is CH₂—CH₂—O (EO).

In one embodiment of the present invention, (AO)ₖ is chosen from —(CH₂CH₂O)ₖ₄, where k1 is chosen from numbers in the range from 1 to 50.

In one embodiment of the present invention, (AO)k is chosen from —(CH₂CH₂O)ₖ₂—(CH₂CH(CH₃)—O)ₖ₃ and —(CH₂CH₂O)ₖ₂-(CH(CH₃)CH₂-O)ₓ₃, where k2 and k3 may be the same or different and are chosen from numbers in the range from 1 to 30.

In one embodiment of the present invention, (AO)ₖ is chosen from —(CH₂CH₂O)ₖ₄, where k4 is in the range from 10 to 50, AO is EO, and R⁸ and R⁹ are independently chosen from C₈-C₁₄-alkyl.

In connection with the present invention, k and k1, k2, k3 and k4 are each understood to mean averages, preference being given to the numerical average. Therefore, each of the variables k and k1, k2, k3 and k4—if present—may mean a fraction. A particular molecule can of course only ever bear a whole number of AO units.

Further examples of suitable nonionic surfactants are compounds of the general formula (VII) and especially of the formula (VII a)

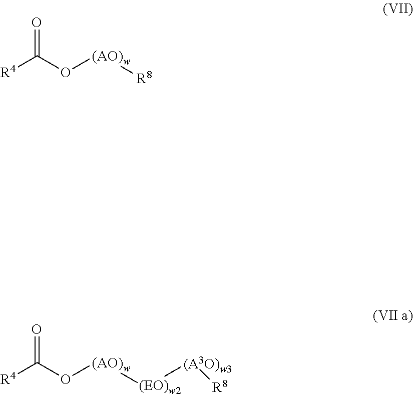

where

R⁴ and AO are as defined above and EO is ethylene oxide, i.e. CH₂CH₂O, where the AO in formula (VII) and (VII a) may each be the same or different,

R⁸ is chosen from C₈-C₁₈-alkyl, linear or branched,

A³O is chosen from propylene oxide and butylene oxide,

w is a number in the range from 15 to 70, preferably 30 to 50,

w1 and w3 are numbers in the range from 1 to 5 and

w2 is a number in the range from 13 to 35.

Further suitable nonionic surfactants are chosen from di- and multiblock copolymers formed from ethylene oxide and propylene oxide. Further suitable nonionic surfactants are chosen from ethoxylated or propoxylated sorbitan esters. Amine oxides or alkyl glycosides are likewise suitable. An overview of suitable further nonionic surfactants can be found in EP-A 0 851 023 and in DE-A 198 19 187.

Mixtures of two or more different nonionic surfactants may also be present.

Examples of anionic surfactants are C₈-C₂₀-alkyl sulfates, C₈-C₂₀-alkyl sulfonates and C₈-C₂₀-alkyl ether sulfates having one to 6 ethylene oxide units per molecule.

In one embodiment of the present invention, formulation of the invention may comprise in the range from 3% to 20% by weight of surfactant.

Formulations of the invention may comprise one or more builders (F), especially phosphate-free builders (F). In the context of the present invention, complexing agent (C) does not count as a builder (F). Examples of suitable builders (F) are silicates, especially sodium disilicate and sodium metasilicate, zeolites, sheet silicates, especially those of the formula α-Na₂Si₂O₅, β-Na₂Si₂O₅, and δ-Na₂Si₂O₅, succinic acid and alkali metal salts thereof, fatty acid sulfonates, α-hydroxypropionic acid, alkali metal malonates, fatty acid sulfonates, alkyl and alkenyl disuccinates, nitrilotriacetic acid, ethylenediaminetetraacetic acid, diethylenetriaminepentaacetic acid, hydroxyethylethylenediaminetriacetic acid, iminodisuccinic acid, hydroxyiminodisuccinic acid, ethylenediaminedisuccinic acid, aspartic acid diacetate and salts thereof, and also carboxyme-thylinulin, tartaric acid diacetate, tartaric acid monoacetate, oxidized starch, and polymeric builders (F), for example polycarboxylates and polyaspartic acid.

Most preferably, formulations of the invention comprise one or more polymeric builders (F). Polymeric builders (F) are understood to mean organic polymers, especially polycarboxylates and polyaspartic acid. Polymeric builders (F) have only a negligible effect, if any, as surfactant.

In one embodiment of the present invention, polymeric builders (F) are chosen from polycarboxylates, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is especially polyacrylic acid, preferably having an average molecular weight M_{w} in the range from 1000 to 40 000 g/mol, preferably 1000 to 10 000 g/mol, especially 1000 to 4000 g/mol. Also suitable are copolymeric polycarboxylates, especially those of acrylic acid with methacrylic acid and of acrylic acid or methacrylic acid with maleic acid and/or fumaric acid.

In one embodiment of the present invention, polymeric builder (F) is chosen from one or more copolymers prepared from at least one monomer from the group consisting of monoethylenically unsaturated C₃-C₁₀ mono- or dicarboxylic acids or anhydrides thereof, such as maleic acid, maleic anhydride, acrylic acid, methacrylic acid, fumaric acid, itaconic acid and citraconic acid, and at least one hydrophilic or hydrophobic comonomer, as enumerated hereinafter.

Suitable hydrophobic monomers are, for example, isobutene, diisobutene, butene, pentene, hexene and styrene, olefins having 10 or more carbon atoms or mixtures thereof, for example 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having an average of 12 to 100 carbon atoms.

Suitable hydrophilic monomers are monomers having sulfonate or phosphonate groups, and nonionic monomers having a hydroxy function or alkylene oxide groups. Examples include: allyl alcohol, isoprenol, methoxy polyethylene glycol (meth)acrylate, methoxy polypropylene glycol (meth)acrylate, methoxy polybutylene glycol (meth)acrylate, methoxy poly(propylene oxide-co-ethylene oxide) (meth)acrylate, ethoxy polyethylene glycol (meth)acrylate, ethoxy polypropylene glycol (meth)acrylate, ethoxy polybutylene glycol (meth)acrylate and ethoxy poly(propylene oxide-co-ethylene oxide) (meth)acrylate. The polyalkylene glycols here comprise 3 to 50, especially 5 to 40 and in particular 10 to 30 alkylene oxide units.

Particularly preferred monomers containing sulfo groups here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide and salts of the aforementioned acids, for example the sodium, potassium or ammonium salts thereof.

Particularly preferred monomers containing phosphonate groups are vinylphosphonic acid and salts thereof.

Furthermore, one or more amphoteric polymers other than graft polymer (B) may be used as polymeric builders (F). Examples of amphoteric polymers are copolymers of at least one ethylenically unsaturated carboxylic acid chosen from acrylic acid and methacrylic acid, at least one amide chosen from N—C₁-C₁₀-alkyl(meth)acrylamide, acrylamide and methacrylamide, and at least one comonomer chosen from DADMAC, MAPTAC and APTAC.

Formulations of the invention may comprise a total of, for example, in the range from 10% to 75% by weight, preferably to 50% by weight, of builders (F), based on the solids content of the formulation of the invention in question.

Formulations of the invention may comprise a total of, for example, in the range from 2% to 15% by weight, preferably to 10% by weight, of polymeric builders (F), based on the solids content of the formulation of the invention in question.

In a particularly preferred embodiment, formulation of the invention comprises, as well as graft polymer (B), a polymeric builder (F). The weight ratio of polymeric builder (F) to graft copolymer (B) in that case is preferably 30:1 to 3:1.

In one embodiment of the present invention, formulations of the invention may comprise one or more cobuilders.

Examples of cobuilders are phosphonates, for example hydroxyalkanephosphonates and ami-noalkanephosphonates. Among the hydroxyalkanephosphonates, 1-hydroxyethane-1,1-diphosphonate (HEDP) is of particular significance as cobuilder. It is preferably used in the form of sodium salt, the disodium salt giving a neutral reaction and the tetrasodium salt an alkaline reaction (pH 9). Useful aminoalkanephosphonates are preferably ethylenediaminetetramethylenephosphonate (EDTMP), diethylenetriaminepentamethylenephosphonate (DTPMP) and the higher homologs thereof. They are preferably used in the form of the neutral sodium salts, for example of the hexasodium salt of EDTMP or of the heptasodium and octasodium salts of DTPMP.

Formulations of the invention may comprise one or more alkali carriers. Alkali carriers ensure, for example, the pH of at least 9 when an alkaline pH is desired. Suitable examples are alkali metal carbonates, alkali metal hydrogencarbonates, alkali metal hydroxides and alkali metal metasilicates. A preferred alkali metal in each case is potassium, more preferably sodium.

Formulations of the invention may comprise one or more acids. Acids ensure the pH of less than 7 when an acidic pH is desired. Suitable acids are, for example, citric acid, tartaric acid and methanesulfonic acid.

Solid formulations of the invention may comprise one or more bleach catalysts. Bleach catalysts may be chosen from bleach-boosting transition metal salts or transition metal complexes, for example salen complexes of manganese, iron, cobalt, ruthenium or molybdenum, or carbonyl complexes of manganese, iron, cobalt, ruthenium or molybdenum. Also usable as bleach catalysts are complexes of manganese, iron, cobalt, ruthenium, molybdenum, titanium, vanadium and copper with nitrogen-containing tripod ligands, and also amine complexes of cobalt, iron, copper and ruthenium.

Solid formulations of the invention may comprise one or more bleach activators, for example N-methylmorpholinioacetonitrile salts (“MMA salts”), trimethylammonioacetonitrile salts, N-acylimides, for example N-nonanoylsuccinimide, 1,5-diacetyl-2,2-dioxohexahydro-1,3,5-triazine (“DADHT”) or nitrile quats (trimethylammonioacetonitrile salts). Further examples of suitable bleach activators are tetraacetylethylenediamine (TAED) and tetraacetylhexylenediamine.

Formulations of the invention may comprise one or more corrosion inhibitors. In the present case, this is understood to mean those compounds that inhibit the corrosion of metal or glass. Examples of suitable corrosion inhibitors are triazoles, especially benzotriazoles, bisbenzotriazoles, aminotriazoles, alkylaminotriazoles, and also phenol derivatives, for example hydroquinone, catechol, hydroxyhydroquinone, gallic acid, phloroglucinol or pyrogallol, and also polyethyleneimine and salts of bismuth or zinc.

In one embodiment of the present invention, formulations of the invention comprise a total in the range from 0.1% to 1.5% by weight of corrosion inhibitor, based on the solids content of the formulation of the invention in question.

Solid formulations of the invention may comprise one or more builder substances, for example sodium sulfate.

Formulations of the invention may comprise one or more defoamers, chosen, for example, from silicone oils and paraffin oils.

In one embodiment of the present invention, formulations of the invention comprise a total in the range from 0.05% to 0.5% by weight of defoamer, based on the solids content of the formulation of the invention in question.

In one embodiment of the present invention, formulations of the invention comprise one or more thickeners.

In order to achieve the desired viscosity of the formulation of the invention in question, one or more thickeners are preferably added to formulations of the invention in gel form, it being found to be particularly advantageous when the formulation of the invention in question comprises thickeners in the range from 0.1% to 8% by weight, preferably from 0.2% to 6% by weight and more preferably from 0.2% to 4% by weight, based on the solids content of the formulation of the invention in question.

Thickeners chosen may be polymers originating from nature or modified natural substances or synthetic thickeners.

Examples of polymers originating from nature that are suitable as thickeners in the context of the present invention include: agar-agar, carrageenan, tragacanth, gum arabic, alginates, pectins, polyoses, guar flour, carob seed flour, starch, dextrins, xanthan, gelatin and casein.

Examples of thickeners from the group of the modified natural substances may be chosen, for example, from the group of the modified starches and celluloses. Examples include carboxymethyl cellulose and other cellulose ethers, hydroxyethyl cellulose and hydroxypropyl cellulose, and seed flour ethers.

Synthetic thickeners are chosen from partly crosslinked poly(meth)acrylic acids, hydrophobically modified polyurethanes (HEUR thickeners) and poly(meth)acrylic acid copolymers esterified with fatty alcohol ethoxylates (HASE thickeners).

A particularly preferred thickener is xanthan.

Formulations of the invention may comprise one or more biocides. Biocides may be added indirectly via the raw materials used, for example by addition of the graft polymers (B), but also separately or additionally. Examples of suitable biocides are isothiazolinones, for example 1,2-benzisothiazolin-3-one (“BIT”), octylisothiazolinone (“OIT”), dichlorooctylisothiazolinone (“DCOIT”), 2-methyl-2H-isothiazolin-3-one (“MIT”) and 5-chloro-2-methyl-2H-isothiazolin-3-one (“CIT”), phenoxyethanol, alkylparabens such as methylparaben, ethylparaben, propylparaben, benzoic acid and salts thereof, for example sodium benzoate, benzyl alcohol, alkali metal sorbates, for example sodium sorbate, and optionally substituted hydantoins, for example 1,3-bis(hydroxymethyl)-5,5-dimethylhydantoin (DMDM hydantoin). Further examples are 1,2-dibromo-2,4-dicyanobutane, iodo-2-propynyl butylcarbamate, iodine and iodophores. Further examples are quaternary ammonium salts, for example dialkyldimethylammonium salts, e.g.

didecyldimethylammonium chloride or benzyldimethylalkylammonium chloride, and cationic polyelectrolytes such as polydimethyldiallylammonium chloride.

In one embodiment of the present invention, formulations of the invention may comprise one or more organic solvents. For example, it is possible to choose organic solvents from the groups of the monoalcohols, diols, triols or polyols, or the ethers, esters and/or amides. Particular preference is given here to organic solvents that are water-soluble, where “water-soluble” solvents in the context of the present application are solvents that are fully miscible, i.e. without a miscibility gap, with water at room temperature.

Organic solvents suitable for formulations of the invention are preferably chosen from the group of mono- or polyhydric alcohols, alkanolamines or glycol ethers that are miscible with water within the concentration range specified. Preference is given to choosing organic solvents from ethanol, n- or i-propanol, butanols, glycol, propane-1,2-diol, or butanediol, glycerol, diglycol, propyl- or n-butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether and mixtures of two or more of the aforementioned organic solvents. Particular preference is given to glycerol and propane-1,2-diol.

In one embodiment, solid formulations of the invention comprise one or more disintegrants, also called tablet disintegrants. Examples are starch, polysaccharides, for example dextrans, and also crosslinked polyvinylpyrrolidone and polyethylene glycol sorbitan fatty acid esters.

In one embodiment of the present invention, formulations of the invention have a pH in the range from 5 to 14, preferably 6 to 10. In the case of those formulations of the invention that are in solid or gel form at room temperature, it is the pH of a 1% aqueous solution or of the liquid phase of a 1% by weight aqueous suspension that is determined.

Formulations of the invention are of good suitability as or for production of cleaning compositions for hard surfaces, for example of ceramic, especially porcelain and stoneware, and also glass, stone, metal and plastic, in the domestic sector, in the private or public sphere, for example toilets, bathrooms, showers or kitchens.

Formulations of the invention are of very good suitability as or for production of dishwashing detergents, especially for machine dishwashing (“automatic dishwashing” or ADW for short). Formulations of the invention themselves and dishwashing detergents produced from formulations of the invention—especially phosphate-free dishwashing detergents produced from formulations of the invention—have very good film inhibition in dishwashing, especially on glassware. More particularly, formulations of the invention are also effective against persistent stains.

Examples of metalware are cutlery, pots, pans and garlic presses, especially cutlery items such as knives, cake slices and serving cutlery.

Examples of glassware include: glasses, glass bowls, glass dishware, for example glass plates, but also articles having at least one glass surface that may be decorated or undecorated, for example glass vases, transparent pan lids and glass vessels for cooking.

Examples of plasticware include plates, cups, mugs and bowls made of melamine, polystyrene, polypropylene and polyethylene. Examples of porcelainware include plates, cups, mugs and bowls made of porcelain, white or colored, in each case with or without decoration.

The present invention therefore further provides for the use of formulations of the invention for washing of dishware and kitchen utensils, especially for machine dishwashing, i.e. for washing with a machine dishwasher. The present invention further provides a method of machine dishwashing using at least one formulation of the invention, also referred to in the context of the present invention as dishwashing method of the invention. The procedure for performance of the dishwashing method of the invention may be such that dishware or kitchen utensils are contacted with an aqueous solution or suspension comprising at least one formulation of the invention. After contacting, the formulation can be left to act. Subsequently, the liquor thus obtainable is removed, and the ware is rinsed once or more than once with preferably clear water and left to dry.

In one embodiment of the present invention, cleaning is accomplished using water having a hardness in the range from 1 to 30° dH (German hardness), preferably 2 to 25° dH, German hardness especially being understood to mean the sum total of magnesium hardness and calcium hardness.

In a particular variant of the dishwashing method of the invention, neither regeneration salt nor separate rinse aid is used.

The present invention further provides a process for producing formulations of the invention, also called production process of the invention in the context of the present invention. The production process of the invention comprises mixing an alkali metal (hydro)sulfite (A), graft copolymer (B) and optionally at least one complexing agent (C) and optionally at least one or more than one further constituent (E) with one another in one or more steps, optionally in the presence of water, and then optionally wholly or partially removing water.

Complexing agent (C), graft copolymer (B) and further constituents (E) have been described above.

In another embodiment of the present invention, complexing agent (C), one or more further constituents (E) are mixed in dry form, and then an aqueous solution of graft copolymer (B) and (bi)sulfite (A), especially alkali metal (bi)sulfite (A) is added, either outside or within a machine dishwasher.

In another embodiment of the present invention, complexing agent (C), graft copolymer (B) and (bi)sulfite (A), especially alkali metal (bi)sulfite (A) and one or more further constituents (E), and also bleach (D) are mixed in dry form, and the mixture thus obtained is pressed to tablets.

In another embodiment of the present invention, complexing agent (C), graft copolymer (B) and (bi)sulfite (A), especially alkali metal (bi)sulfite (A) and one or more further constituents (E) are mixed in dissolved form, and a formulation in gel form is produced by partially removing water.

In another embodiment of the present invention, complexing agent (C), graft copolymer (B), at least one thickener and one or more further constituents (E) are mixed in dry form, and a formulation in gel form is produced by adding water.

In one embodiment of the present invention, before the water is at least partly removed, mixing is possible with one or more further constituents (E) for formulation of the invention, for example with one or more surfactants, one or more enzymes, one or more enzyme stabilizers, one or more builders (F), preferably one or more phosphate-free builders (F), especially one or more polymeric builders (F), one or more cobuilders, one or more alkali carriers or acids, one or more defoamers, one or more corrosion inhibitors, one or more builder substances, with buffer or dye.

In one embodiment, the procedure is to wholly or partly remove the water, for example down to a residual moisture content in the range from zero to 15% by weight, preferably 0.1% to 10% by weight, from solid formulation of the invention by evaporating it, especially by spray drying, spray pelletization or compaction.

In one embodiment of the present invention, water is removed at a pressure in the range from 0.3 to 2 bar.

In one embodiment of the present invention, water is removed at temperatures in the range from 60 to 220° C.

In another embodiment, the water is not removed. Instead, further water can be added. Particular preference is also given to adding a thickener. In this way, it is possible to obtain formulations of the invention in gel form.

By the production process of the invention, it is easily possible to obtain formulations of the invention.

The formulations of the invention can be provided in liquid form, for example in gel or paste form, or in solid form, in one or more phases, as tablets or in the form of other dosage units, for example as what are called pouches, in packed or unpacked form.

The invention is further illustrated by working examples.

### EXAMPLES

### I. Production of Formulations of the Invention and of Comparative Formulations

In the context of the present application, figures in % are percent by weight, unless explicitly stated otherwise.

Graft copolymer (B.1) corresponds to graft copolymer (B.4) from WO 2015/197379. It was pre-pared as follows:

Preparation of Graft Copolymer (B.1)

A stirred reactor was initially charged with 220 g of (c.1) in 618 g of water and heated to 80° C. while stirring. At 80° C., the following solutions were metered in simultaneously and via separate feeds as follows:

a) an aqueous solution of 40.6 g of (a.1) in 149 g of water, within 4 hours.

b) a solution of 9.85 g of sodium peroxodisulfate in 68.0 g of water within 5 h, commencing simultaneously with the metered addition of a).

c) a solution of 32.8 g of (b.1) and 36.5 g of sodium hydroxide solution (50% in water), diluted with 139 g of water, within 2 hours, commencing 2 hours after commencement of metered addition of a).

On completion of addition of solutions a) to c), the reaction mixture was stirred at 80° C. for one hour. Subsequently, a solution of 0.73 g of sodium peroxodisulfate in 10.0 g of water was added and the mixture was stirred at 80° C. for a further 2 hours. This was followed by cooling to 20° C. and addition of 8 g of biocide. This gave a 22.4% by weight solution of graft copolymer (B.1).

The biocide used was a 9% by weight solution of 1,2-benzisothiazolin-3-one in water-propylene glycol mixture, commercially available as Proxel™ XL2 Antimicrobial. Stated amounts for biocide are tel quel.

The liquid base detergent formulation below was produced, with the starting weights each based on the solids content.

TABLE 1
Base detergent formulation

| Substance | Active ingredient or solids [g] |
|---|---|
| Glycerol | 50 |
| (C.1) | 150 |
| (C.2) | 50 |
| (E.1) | 50 |
| HEDP, Na salt | 10 |
| Citric acid | See below |
| Graft copolymer (B.1) | 2.5 |

350 mL of demineralized water was first initially charged and then the substances according to table 1 were added while stirring.

(C.1): MGDA-Na₃ as 40% aqueous solution

(C.2): trisodium citrate.2 H₂O

(E.1): polyacrylic acid, M_{w} 2000 g/mol, fully neutralized with NaOH

Subsequently, addition according to table 2 was added and the mixture was made up to one liter with demineralized water.

If required, sufficient citric acid was added here to establish a pH of 6, 7 or 8. Pale yellow detergent formulations were obtained.

The formulations thus obtainable were stored at +40° C. over a period of 10 weeks. Subsequently, the color was determined. Formulations without polymer (B.1) did show comparatively good color values, but showed unsatisfactory cleaning results.

TABLE 2
inventive formulations and comparative
formulations, and storage tests

| Formulation | (B.1) | Addition | pH | Color after storage test |
|---|---|---|---|---|
| C-F.1 | — | — | 8 | pale yellow |
| C-F.2 | 1.0 | — | 8 | yellow |
| C-F.3 | 1.0 | 0.4% (D.1) | 8 | yellow |
| F.4 | 1.0 | 0.4% (A.1) | 8 | pale yellow |
| C-F.5 | 1.0 | 0.4% vitamin C | 8 | amber |
| C-F.6 | — | — | 7 | pale yellow |
| C-F.7 | 1.0 | — | 7 | yellow |
| C-F.8 | 1.0 | 0.4% (D.1) | 7 | yellow |
| F.9 | 1.0 | 0.4% (A.1) | 7 | pale yellow |
| C-F.10 | 1.0 | 0.4% vitamin C | 7 | dark red |
| C-F.11 | — | — | 6 | yellow |
| C-F.12 | 1.0 | — | 6 | yellow |
| C-F.13 | 1.0 | 0.4% (D.1) | 6 | yellow |
| F.14 | 1.0 | 0.4% (A.1) | 6 | pale yellow |
| C-F.15 | 1.0 | 0.4% vitamin C | 6 | dark red-brown |

(A.1): Na₂SO₃
(D.1): H₂O₂

Percentages are % by weight and relate to the solids content, i.e. without water and without glycerol.

1. A solid, liquid, or gel formulation comprising:
(A) ammonium sulfite or ammonium bisulfite or alkali metal sulfite or alkali metal bisulfite, and
(B) at least one graft copolymer formed from
(a) at least one graft base selected from nonionic monosaccharides, disaccharides, oligosaccharides, and polysaccharides, and
(b) side chains obtainable by grafting of
(1) at least one ethylenically unsaturated mono- or dicarboxylic acid, and
(2) at least one compound of the general formula (I), 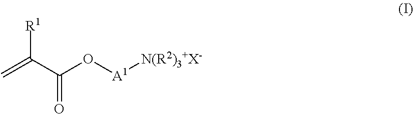
where the variables are each defined as follows:
R¹ is chosen from methyl and hydrogen,
A¹ is chosen from C₂-C₄-alkylene,
R² are the same or different and chosen from C₁-C₄-alkyl,
X⁻ is chosen from halide, mono-C₁-C₄-alkylsulfate and sulfate,
where (bi)sulfite (A) and graft copolymer (B) are present in a weight ratio in the range from 1:100 to 10:1.

2. The formulation according to claim 1, which is free of enzymes.

3. The formulation according to claim 1, which is free of phosphates and polyphosphates.

4. The formulation according to claim 1, wherein (bi)sulfite (A) is chosen from alkali metal sulfite and alkali metal bisulfite.

5. The formulation according to claim 1, wherein compound (2) is chosen from w-trimethylaminoethyl (meth)acrylatochloride.

6. The formulation according to claim 1, which further comprises at least one complexing agent (C) chosen from alkali metal salts of methylglycinediacetic acid (MGDA), glutamic acid diacetate (GLDA), and citric acid, and combinations of at least two of the above.

7. The formulation according to claim 1, further comprising at least one polymeric builder (F).

8. The formulation according to claim 1, which is in liquid or gel form at 20° C.

9. The formulation according to any claim 1, which comprises:
a total in the range from 0.005% to 2% by weight of (bi)sulfite (A), and
a total in the range from 0.05% to 4% by weight of graft copolymer (B), based in each case on the solids content of the formulation.

10. A method of using formulations according to claim 1, the method comprising using the formulations for washing of dishware and kitchen utensils.

11. A method of using formulations according to claim 1, the method comprising using the formulations for washing of articles having at least one glass surface that is decorated or undecorated.

12. The method according to claim 10, wherein the washing is a washing operation with a machine dishwasher.

13. A process for producing formulations according to claim 1, the method comprising mixing at least one (bi)sulfite (A) and at least one graft copolymer (B) and optionally one or more further ingredients (F) and optionally polymeric builders (F) with one another in one or more steps in the presence of water.
